(19) United States
(12) Patent Application Publication
(10) Pub. No.: US 2009/0229478 A1
(43) Pub. Date: Sep. 17, 2009

(54) FRUIT/VEGETABLE JUICE SPINNING FILTER

(76) Inventor: TE-SHENG WU, Taoyuan County (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/046,968

(22) Filed: Mar. 12, 2008

(51) Int. Cl. A23N 1/00; B01D 21/26

(52) U.S. Cl. 99/495; 210/512.1

(57) ABSTRACT

A fruit/vegetable juice spinning filter includes a container, a strainer basket, and a cover. The container internally defines a chamber and is provided with a bottom opening and a juice outlet. The strainer basket is disposed in the chamber of the container to define a filtered juice receiving space between the container and the strainer basket. The strainer basket has a spinning shaft downward extended through the bottom opening of the container to associate with an external rotary drive source. The cover closes a top of the container and the strainer basket. When an amount of primarily extracted and pulp-containing fruit/vegetable juice is poured into the strainer basket, and the spinning shaft and accordingly the strainer basket are driven by the external rotary drive source to spin, the primarily extracted juice in the strainer basket is centrifugally separated from the pulp to produce almost pulp-free juice.

### FIELD OF THE INVENTION

The present invention relates to a fruit/vegetable juice spinning filter, and more particularly to a fruit/vegetable juice spinning filter enabling enhanced fruit/vegetable juice extracting function.

### BACKGROUND OF THE INVENTION

In general family life, a fruit/vegetable juice extractor is frequently used to extract fruit/vegetable juice, which is not only tasty to drink, but also nutritious and good for the health.

The currently commercially available fruit/vegetable juice extractor, as suggested by the name, has only one simple function of extracting juice from fruit/vegetable. A conventional fruit/vegetable juice extractor includes a container for containing fruits/vegetables. A rotary cutter is arranged in the container to be driven by a rotary force from a motor of the juice extractor for extracting juice from the fruits/vegetables contained in the container.

The extracted fruit/vegetable juice is pulp-containing and received in the container, and may be poured into a cup or the like for drinking. Before pouring the extracted juice into the cup, a strainer may be used to filter off the pulp so as to obtain almost pulp-free fruit/vegetable juice.

People would generally discard the filtered-off pulp. However, there is still some juice remaining in the pulp. It is an unnecessary waste to discard the juice-containing pulp.

It is therefore tried by the inventor to develop a fruit/vegetable juice spinning filter for further collecting juice remained in the pulp, so as to provide enhanced fruit/vegetable juice extracting function.

### SUMMARY OF THE INVENTION

A primary object of the present invention is to provide a fruit/vegetable juice spinning filter which enables enhanced fruit/vegetable juice extracting function.

To achieve the above and other objects, the fruit/vegetable juice spinning filter of the present invention includes a container, a strainer basket, and a cover. The container internally defines a chamber, and is provided with a bottom opening and a juice outlet. The bottom opening and the juice outlet communicate the chamber with an outer side of the container.

The strainer basket is disposed in the chamber of the container to define a filtered juice receiving space between the container and the strainer basket. The strainer basket internally defines an extracted juice chamber, and is provided with a spinning shaft downward extended through the bottom opening of the container to outward project from the container.

The cover is covered onto a top of the container to close the chamber of the container and the extracted juice chamber of the strainer basket. The cover is formed with an inlet communicating with the extracted juice chamber of the strainer basket. The fruit/vegetable juice spinning filter of the present invention further includes a funnel which is placed on the cover to downward extend through the inlet and thereby communicates with the extracted juice chamber.

Through the funnel, the pulp-containing fruit/vegetable juice obtained using a conventional fruit/vegetable juice extractor may be conveniently poured into the extracted juice chamber of the strainer basket. The spinning shaft of the strainer basket is coupled with an external spinning motor base for driving the strainer basket to spin. When the strainer basket is driven to spin, not only the extracted fruit/vegetable juice, but also the juice remained in the pulp is centrifugally separated from the pulp. Therefore, an almost pulp-free fruit/vegetable juice is produced, and the juice remained in the pulp is not wasted.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a fruit/vegetable juice spinning filter according to a preferred embodiment of the present invention;

FIG. 2 is an assembled perspective view of FIG. 1;

FIG. 3 is a vertical sectional view of FIG. 2;

FIG. 4 is a perspective view showing that the present invention is associated with an external spin motor base for use;

FIG. 5 is a vertical sectional view of FIG. 4 with an amount of extracted and pulp-containing fruit/vegetable juice poured into a strainer basket; and

FIG. 6 shows the strainer basket of the present invention is spun, so that all juice is centrifugally separated from the pulp and collected in a container.

### DETAILED DESCRIPTION OF THE PREFERRED EMBODIMENTS

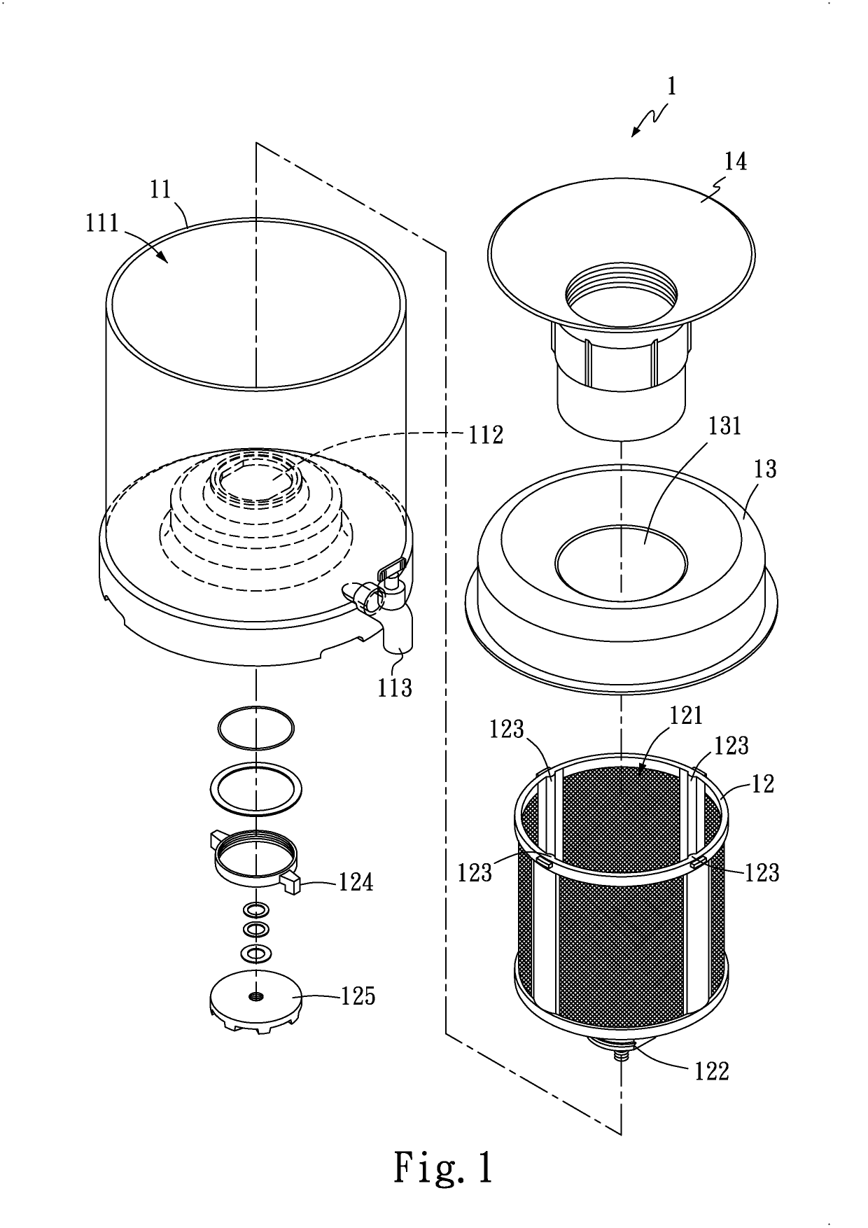

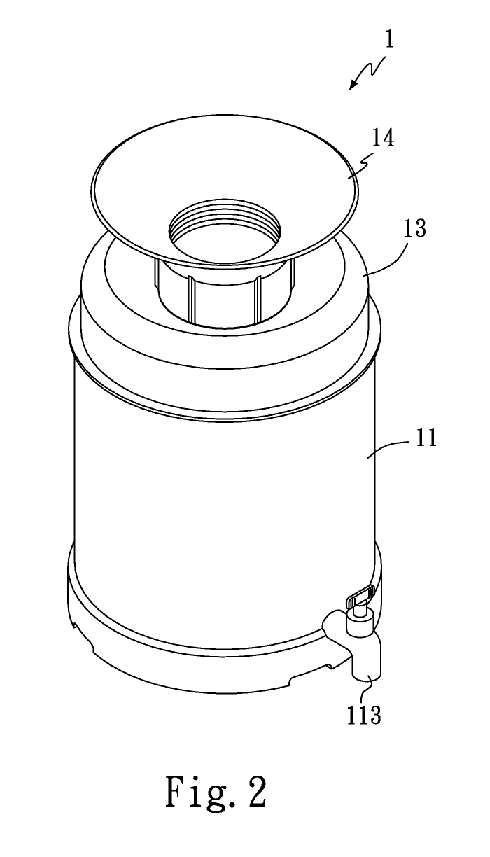

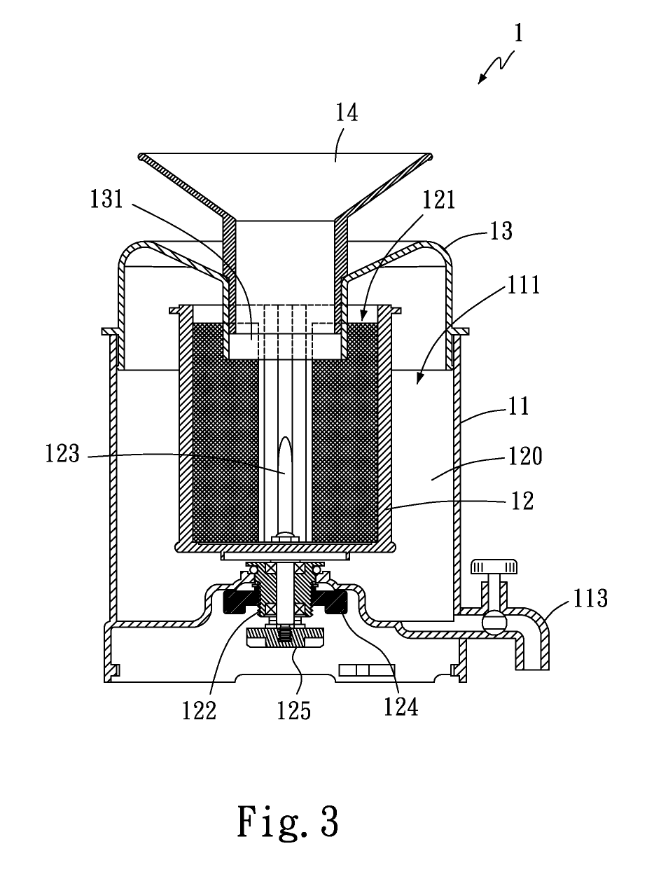

Please refer to FIGS. 1 and 2 that are exploded and assembled perspective views, respectively, of a fruit/vegetable juice spinning filter 1 according to a preferred embodiment of the present invention, and to FIG. 3 that is a vertical sectional view of FIG. 2. As shown, the fruit/vegetable juice spinning filter 1 includes a container 11, a strainer basket 12, and a cover 13.

The container 11 internally defines a chamber 111, and is provided at predetermined positions with a bottom opening 112 and a juice outlet 113. The bottom opening 112 and the juice outlet 113 communicate the chamber 111 with an outer side of the container 11. In the illustrated preferred embodiment, the juice outlet 113 is a spout.

The strainer basket 12 is disposed in the chamber 111 of the container 11, so that a filtered juice receiving space 120 is defined between the strainer basket 12 and the container 11. The strainer basket 12 internally defines an extracted juice chamber 121 and is provided at a bottom with a spinning shaft 122. The spinning shaft 122 is downward extended through the bottom opening 112 of the container 11 to outward project from the container 11.

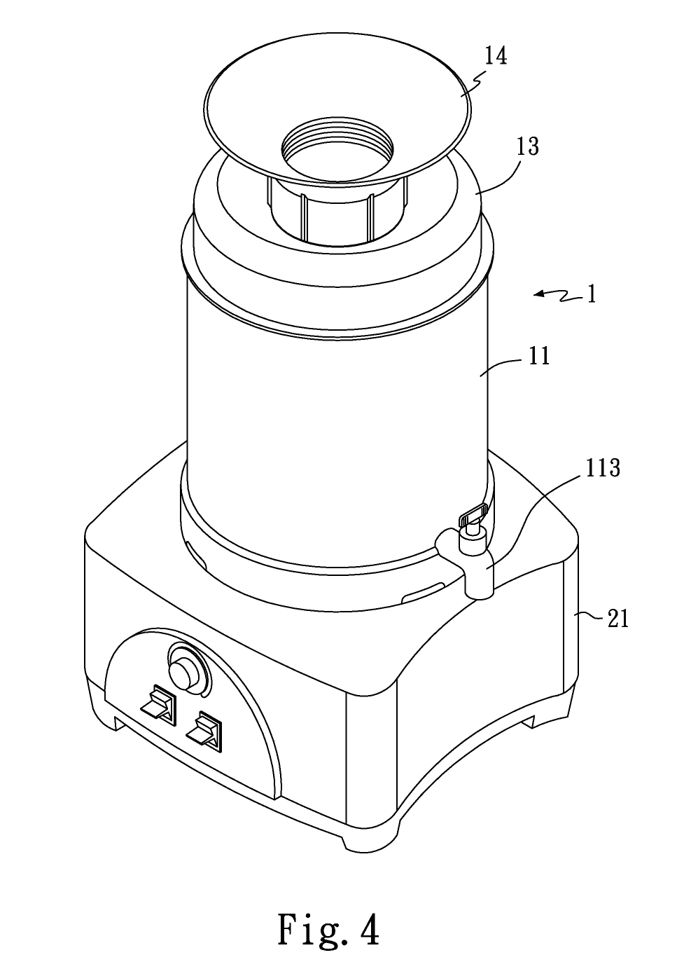

In the illustrated preferred embodiment, the strainer basket 12 has four reinforcing ribs 123 to give the strainer basket 12 an increased structural strength. In addition, a locking ring 124 is screwed to the spinning shaft 122 for firmly locking the strainer basket 12 to the container 11, as can be seen from FIG. 3. Furthermore, the spinning shaft 122 is equipped with a coupler 125 for coupling with an external spin motor base 21, as shown in FIG. 4. Herein, the external spin motor base 21 is a base of a conventional fruit/vegetable juice extractor.

The cover 13 is removably covered onto a top of the container 11 for closing the chamber 111 and the extracted juice chamber 121 of the strainer basket 12.

In the illustrated embodiment, the cover 13 is formed with an inlet 131 communicating with the extracted juice chamber 121 of the strainer basket 12. A funnel 14 can be placed on the cover 13 to downward extend through the inlet 131 to communicate with the extracted juice chamber 121.

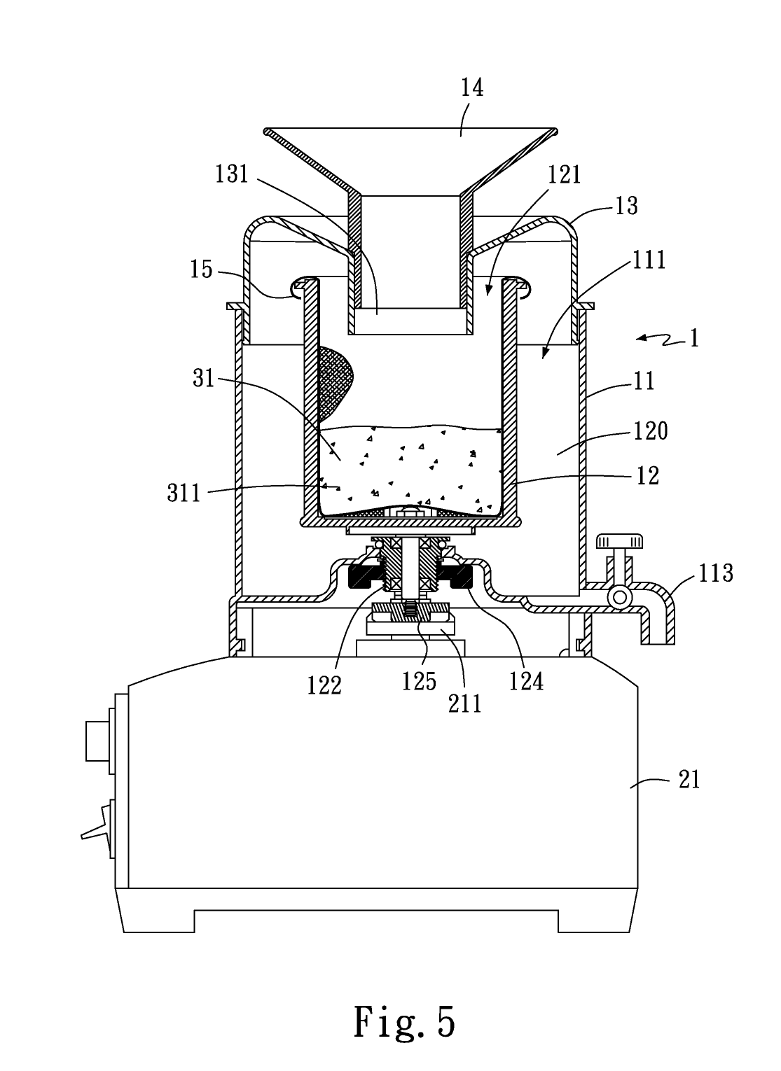

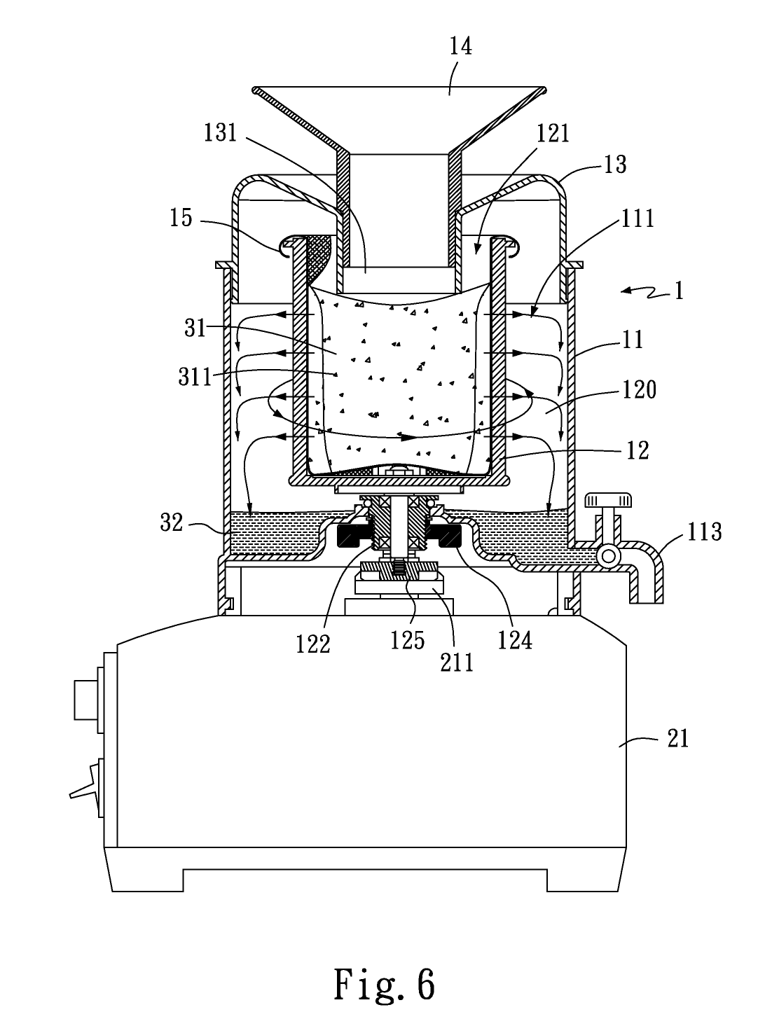

Referring to FIGS. 4 to 6, which shows the use of the fruit/vegetable juice spinning filter 1 to further filter pulp-containing fruit/vegetable juice 31 produced by a conventional fruit/vegetable extractor. To do so, the fruit/vegetable juice spinning filter 1 is rested on and associated with the external spin motor base 21. The spin motor base 21 pertains to prior art and thus will not be described in details hereinafter. The coupler 125 on the spinning shaft 122 is coupled with a drive source 211 of the external spinning motor base 21.

Through the funnel 14, the primarily extracted and pulp-containing fruit/vegetable juice 31 is conveniently poured into the extracted juice chamber 121 of the strainer basket 12 for subsequent spin-filtering.

A filter paper 15 may be placed in the extracted juice chamber 121 to overlay the strainer basket 12. The filter paper 15 has finer filter meshes to enable enhanced filter effect.

When the external spin motor base 21 is powered on, the drive source 211 and the coupler 125 coupled therewith are driven to spin, bringing the strainer basket 12 to spin at the same time. In this manner, the fruit/vegetable juice 31 in the extracted juice chamber 121 of the strainer basket 12 and juice remained in the pulp 311 is centrifugally separated from the pulp 311 to produce almost pulp-free fruit/vegetable juice 32. The pulp-free fruit/vegetable juice 32 is collected in the filtered juice receiving space 120 between the strainer basket 12 and the container 11. A user may then open the juice outlet (the spout) 113, allowing the pulp-free fruit/vegetable juice 32 to flow into a cup or the like (not shown) for serving or drinking.

With the above arrangements, the fruit/vegetable juice spinning filter of the present invention not only filters off the pulp 311 from the extracted fruit/vegetable juice 31 to produce the pulp-free juice 32, but also fully extracts the fruit/vegetable juice remained in the pulp 311. Therefore, the prevent invention provides enhanced juice extracting function without wasting the juice remained in the pulp 311.

In the case relatively fine pulp 311 is contained in the primarily extracted juice, the filter paper 15 with even finer filter meshes may be used to assist the strainer basket 12 in filtering off the fine pulp. When the juice spin-filtering is completed, the filter paper 15 can be conveniently removed from the strainer basket 12 to facilitate subsequent cleaning of the whole fruit/vegetable juice spinning filter 1.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A fruit/vegetable juice spinning filter comprising:
a container internally defining a chamber and being provided at predetermined positions with a bottom opening and a juice outlet, the bottom opening and the juice outlet communicating the chamber with an outer side of the container;
a strainer basket being disposed in the chamber of the container to define a filtered juice receiving space between the strainer basket and the container; the strainer basket internally defining an extracted juice chamber and being provided at a bottom with a spinning shaft; and the spinning shaft being downward extended through the bottom opening the container to project outward; and
a cover being removably covered onto a top of the container for closing the chamber of the container and the extracted juice chamber of the strainer basket.

2. The fruit/vegetable juice spinning filter as claimed in claim 1, further comprising a funnel; and wherein the cover is formed with an inlet communicating with the extracted juice chamber of the strainer basket, and the funnel is placed on the cover to downward extend through the inlet to communicate with the extracted juice chamber.

3. The fruit/vegetable juice spinning filter as claimed in claim 1, further comprising a filter paper which is removably placed in the extracted juice chamber to overlay the strainer basket.

4. The fruit/vegetable juice spinning filter as claimed in claim 1, wherein the strainer basket is provided with at least one reinforcing rib.

5. The fruit/vegetable juice spinning filter as claimed in claim 1, wherein the spinning shaft has a locking ring screwed thereto.

6. The fruit/vegetable juice spinning filter as claimed in claim 1, wherein the spinning shaft has a coupler associated therewith for coupling with an external rotary drive source.

7. The fruit/vegetable juice spinning filter as claimed in claim 1, wherein the juice outlet is a spout.
